(19) United States
(12) Patent Application Publication
(10) Pub. No.: US 2009/0010500 A1
(43) Pub. Date: Jan. 8, 2009

(54) Face Recognition Methods and Systems

(76) Inventors: Umasankar Kandaswamy, Potsdam, NY (US); Donald A. Adjeroh, Morgantown, WV (US); Natalia Schmid, Morgantown, WV (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/133,479

(22) Filed: Jun. 5, 2008

Related U.S. Application Data
(60) Provisional application No. 60/933,265, filed on Jun. 5, 2007.

(51) Int. Cl. G06K 9/74

(52) U.S. Cl. 382/118

(57) ABSTRACT

Various systems and methods are provided for face recognition. In one embodiment, a method includes assigning a texton to each pixel of a filtered image to produce a texton map; determining an approximation error for each pixel of the texton map; segmenting the texton map into a plurality of sub-blocks, each sub-block associated with a plurality of pixels of the texton map; determining an average error for at least one sub-block based upon the approximation errors of the pixels associated with the at least one sub-block; determining a weight for the at least one sub-block based upon the average error; assigning the weight to the textons assigned to the pixels associated with the at least one sub-block; and producing an error encoded histogram based upon the textons and the assigned weights.

### CROSS REFERENCE TO RELATED APPLICATIONS

This application claims priority to copending U.S. provisional application entitled “ERROR ENCODED PDE-TEXTONS FOR FACE RECOGNITION” having Ser. No. 60/933,265, filed Jun. 5, 2007, which is entirely incorporated herein by reference.

### BACKGROUND

Image recognition and its automation is a current area of research. This also applies to face recognition. Pattern analysis of the images may be utilized for recognition. These methods often depend upon the a priori information (e.g., the type, number, and quality of training images) that are available. Variations in the training images including variations in direction (position of the camera) and direction of light source can affect later recognition.

In the field of face recognition, techniques such as principal component analysis (PCA) and linear discriminant analysis (LDA) address the effective, efficient, automated scene content analysis and recognition under varying illumination conditions, and different viewing directions by either increasing the number or quality of training images. In general, the PCA and LDA approaches project a given face image onto a space spanned by the principal components extracted from a set of training face images.

In “Eigenfaces for face recognition” by M. Turk and A. Pentland (Journal of Cognitive Neuroscience, vol. 3, no. 1, pp. 71-86, January 1991), the entirety of which is hereby incorporated by reference, the principal components of M number of training images, each of size N×N, could be extracted by determining the eigenvectors of a much smaller matrix (relative to N²×N²) of size M×M. The face image to be recognized is projected into a face space, and the resultant projection is compared with the projections of training images. The class of the nearest projection is identified as the class of the input face image. One drawback of PCA is that while increasing the interclass distance between the face images, the intraclass distances are also increased. “Eigenfaces vs. Fisherfaces: recognition using class specific linear projection,” by P. N. Belhumeur, J. P. Hespanha, and D. J. Kriegman (IEEE Transactions on Pattern Analysis and Machine Intelligence, vol. 19, no. 7, pp. 711-720, July 1997), the entirety of which is hereby incorporated by reference, proposed LDA that uses Fisher's Linear Discriminant (FLD) principle to shape the scatter of principal components in such a way that their interclass distance is maximized while decreasing intraclass distances.

While initially considered an advantage, the dependence upon a priori information was found to be a drawback because performance varies significantly with respect to the type and number of training images. Even with a good set of training images, including facial images, approaches based on principal component analysis often fail to capture the individual signature of the biometric data.

The texture of natural images, including facial images, may also be considered during image analysis. Improved performance of face recognition systems may be provided by using textural signatures extracted using texture analysis schemes, such as those based on Gabor-Wavelets and Local Binary Patterns (LBP). Gabor wavelet representation of face images is described in “Gabor feature based classification using the enhanced fisher linear discriminant model for face recognition” by C. Liu and H. Wechsler (IEEE Transactions on Image Processing, vol. 11, no. 4, pp. 467-476, April 2002), the entirety of which is hereby incorporated by reference. Local Binary Pattern representation of face images is described in “Face recognition with local binary patterns” by T. Ahonen, A. Hadid, and M. Pietikainan (Proceedings of European Conf. of Computer Vision, pp. 469-4816, May 2004), the entirety of which is hereby incorporated by reference.

In general, a LBP operator assigns a binary number for each pixel of an image by thresholding the 3×3 neighborhood of each pixel using the pixel value at the center. A histogram of the assigned indices is then used as the feature to represent the textural image. In “Multiresolution gray-scale and rotation invariant texture classification with local binary patterns” by T. Ojala, M. Pietikäinen, and T. Mäenpää (IEEE Transactions on Pattern Analysis and Machine Intelligence, vol. 24, no. 7, pp. 971-987, July 2002), the entirety of which is hereby incorporated by reference, histogram features corresponding to different scales (i.e. different neighborhood sizes) may represent different kinds of features.

### SUMMARY

Embodiments of the present disclosure are related to face recognition methods and systems.

Briefly described, one embodiment, among others, comprises a method. The method comprises assigning a texton to each pixel of a filtered image to produce a texton map; determining an approximation error for each pixel of the texton map; segmenting the texton map into a plurality of sub-blocks, each sub-block associated with a plurality of pixels of the texton map; determining an average error for at least one sub-block based upon the approximation errors of the pixels associated with the at least one sub-block; determining a weight for the at least one sub-block based upon the average error; assigning the weight to the textons assigned to the pixels associated with the at least one sub-block; and producing an error encoded histogram based upon the textons and the assigned weights.

Another embodiment, among others, comprises a method. The method comprises assigning a texton to a pixel of a filtered image; determining an approximation error associated with the pixel; determining a weight associated with the texton assigned to the pixel, the weight based upon the approximation error associated with the pixel; and producing an error encoded histogram based upon the texton and the associated weight.

Another embodiment, among others, comprises a system. The system comprises means for assigning a texton to a pixel of a filtered image; means for determining an approximation error associated with the pixel; means for determining a weight associated with the texton assigned to the pixel, the weight based upon the approximation error associated with the pixel; and means for producing an error encoded histogram based upon the texton and the associated weight.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a flow diagram illustrating a method for determining textons in accordance with an embodiment of the present disclosure;

FIG. 2 is a flow diagram illustrating a method for mapping an image using textons determined in FIG. 1 in accordance with an embodiment of the present disclosure;

FIG. 3 is an illustration of mapping an image to a texton map using the method of FIG. 2 in accordance with an embodiment of the present disclosure;

FIG. 4 is a schematic block diagram of one example of a system employed to perform various analysis with respect to face recognition according to an embodiment of the present disclosure; and

FIG. 5 is a plot of experimental results comparing face recognition schemes including error encoded PDE-textons in accordance with an embodiment of the present disclosure.

### DETAILED DESCRIPTION

Disclosed herein are various embodiments of methods related to face recognition methods and systems. Reference will now be made in detail to the description of the embodiments as illustrated in the drawings, wherein like reference numbers indicate like parts throughout the several views.

The statistical characteristics of natural images may be studied from the perspective of compression and image coding. General measures, such as the conditional entropy of the pixel intensity given the intensities of its neighboring pixels and the correlation between adjacent pixels, may be used for predicting redundancies in natural images. Other higher order statistics, such as, the kurtosis of the distribution of Gabor filter responses and gradient filter responses may also be used to reveal the structural properties of natural images. Representing an image as a superposition of different image components or decomposing an image into smaller accessible units of information may also be utilized. For example, generative modeling, where an image is represented using a dictionary composed of a small number of sparse basis functions (e.g., sparse coding with over-complete basis) may be used.

For these methods, key-features may be extracted from the shape and textural features of a face for more effective analysis than regular appearance-based approaches. The extracted key-features may also provide a better handle to the problem of intra-class variations in biometric data. However, a drawback of LBP based systems is their inability to eliminate erroneous regions from comparison. Non-ideal conditions, such as, but not limited to, variations in lighting, orientation, and expression, can adversely affect the image recognition. For example, if a test image has a different expression than that of the training image, the region altered by the changed expression affects the pattern analysis of the image. Reducing the effect of such erroneous regions by giving the altered areas less weight compared to the regions that are not altered may improve the image recognition.

Decomposition based on perceptual grouping (e.g., discriminative modeling) may improve pattern analysis under non-ideal conditions. For pattern recognition applications, methods based on discriminative modeling of natural images, such as textons, work for textured surfaces. Textons refer to generic descriptors that may be combined to make up an image. The variations and texture of an image may be described by responses to a set of filters, which may include linear and/or non-linear functions. Combinations of the responses may be used to define textons.

Representation of three-dimensional textured surfaces using 3D-textons based upon a set of orientation and spatial-frequency selective linear functions is described in “Representing and recognizing the visual appearance of materials using three-dimensional textons” by T. Leung and J. Malik (International Journal of Computer Vision, vol. 43, no. 1, pp. 29-44, June 2001), the entirety of which is hereby incorporated by reference. Different viewing conditions may be analyzed using 3D-textons including variations in direction (i.e., position of the camera) and direction of light source. Statistical approaches to texture classification using different sets of linear filters, such as that described in “A statistical approach to texture classification from single images” by M. Varma and A. Zisserman (International Journal of Computer Vision, vol. 62, no. 1-2, pp. 61-81, April 2005), the entirety of which is hereby incorporated by reference, may also be used.

Variations of the surface normal on 3D textured surfaces, such as those due to specularities, shadows and occlusions can affect images of the surface. A discriminative modeling paradigm may use textons as generic descriptors of a textured surface image. The present disclosure presents a process for determining partial derivative (PDE) based textons, which considers both linear and nonlinear variations that may be present in the neighborhood of each pixel in an image to obtain a representative texton. These variations can be captured by using a combination of linear and/or nonlinear filters to represent the neighborhood of each pixel position in the image. For a given pixel position, the difference between the neighborhood characteristics of the actual pixel and the characteristics of its representative texton may be computed. This residual information (or error) may be used to estimate the importance of textural features extracted from the texton representation.

A face image may be defined as a superposition of a number of image bases selected from an over-complete dictionary Ψ, which may include, but is not limited to, edge filters and Gabor and Gaussian bases at various orientations. The image bases, denoted as base map B, are represented as attributed points. The base map B is, in turn, generated by a smaller collection of elements called textons, denoted by texton map T, which are collected from a dictionary of textons Π.

I [symbol] B(Ψ) [symbol] T(Π)

A more detailed description of textons is provided in “What are textons?” by Song-Chun Zhu, Cheng-En Guo, Yizhou Wang, and Zijian Xu, (International Journal of Computer Vision, vol. 62, no. 1/2, pp. 121-143, April 2005), the entirety of which is hereby incorporated by reference.

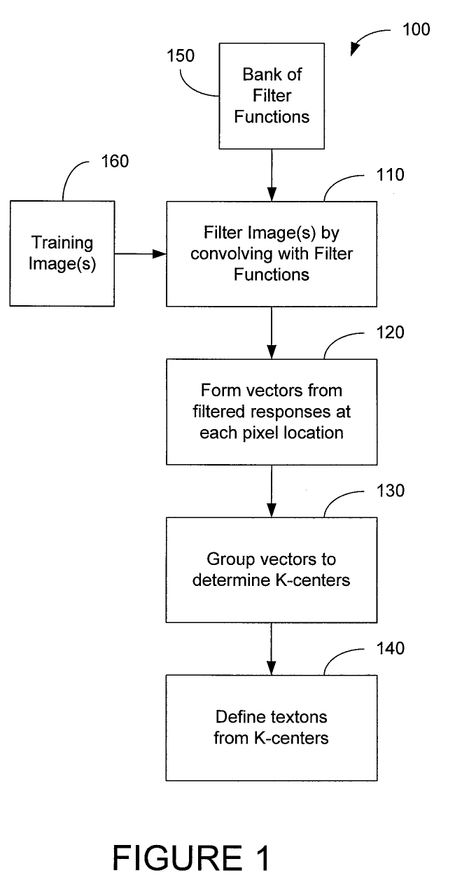

FIG. 1 is a flow diagram 100 illustrating a method for determining textons in accordance with an embodiment of the present disclosure. A filter bank 150 of base functions (e.g., a set of filters obtained at different scales and orientations), defined as {F₁, F₂, . . . , Fₘ}, may be used as filters. The filter functions may include linear and nonlinear functions such as, but not limited to, Gabor cosine and partial derivative functions. Other linear and non-linear functions include, but are not limited to, Fourier, wavelet decomposition, Radial basis, spline, and Laplacian of Gaussian.

In one embodiment, the filter bank 150 is fixed with two common base functions: Gabor cosine and partial derivative (PDE) functions using the neighborhood pixel values, i.e.,

Ψ={ψ₁,ψ₂}={G cos,∇_{gh}I},

where ∇ is the partial derivative operator. The subscripts, g and h are the scale and orientation operators, respectively. In one embodiment, the parameter h is restricted to eight neighborhood pixel values. In other embodiments, the parameter h may be a different number of neighborhood pixel values such as, but not limited to, twelve and sixteen neighboring pixel values. By increasing the h parameter, the computational efficiency at the stage of learning generic texton dictionary Π for face images may be increased.

In other embodiments, linear filters may be utilized such as, but not limited to, the 48 filters (36 elongated filters—3 scales, 6 orientations and 2 phases, 8 center-surround difference of Gaussian filters and 4 low-pass filters) described in “Representing and recognizing the visual appearance of materials using three-dimensional textons” by T. Leung and J. Malik (International Journal of Computer Vision, vol. 43, no. 1, pp. 29-44, June 2001), the entirety of which is hereby incorporated by reference, and the 38 filters, namely two rotationally symmetric (Gaussian and LoG) filters with scale of 10 pixels, a set of edge and bar filters at 3 scales ((σₓ, σ_{y})={(1, 3), (2, 6), (4, 12)}) and 6 orientations, described in “A statistical approach to texture classification from single images” by M. Varma and A. Zisserman (International Journal of Computer Vision, vol. 62, no. 1-2, pp. 61-81, April 2005), the entirety of which is hereby incorporated by reference.

The filters are convolved with a given input training image 160 I(x, y) in block 110 and the resultant filter responses, Fᵣ, are stacked to form an m-dimensional vector at each pixel location in the image in block 120:

Fᵣ={Fᵣ(x,y)=(F₁*I(x,y), . . . , Fₘ*I(x,y)), . . . }, ∀(x,y)εΛ,

where Λ is the image lattice and * is the convolution operator. In the case where more than one image is evaluated, the filter responses from the images are concatenated. In some embodiments, the filter responses may be L1 normalized individually before stacking to form the vectors at each pixel location.

In block 130, the vectors (formed at each pixel position in the image) may be grouped to find K-centers. A K-means algorithm finds a local minimum of a sum-of-square distance error between the vector for the center and a response vector assigned to the center. In one embodiment, vectors are grouped by determining when the squared distances from a center and the vectors assigned to the center are minimized for all K-centers. In other embodiments, groups are determined when the squared distances all fall below a predetermined value. In alternative embodiments, a predetermined value may be assigned to each center. In the case where more than one image is evaluated and the filter responses are concatenated, K-centers may be formed iteratively until a certain local minima is achieved. The centers are then used to define K generic descriptors (i.e., textons) of the textured surface in block 140. These cluster centers are used for representing the images in the database. In some embodiments, the textons are assigned a texton-ID from 1 to K. In one embodiment where the filter functions are Gabor cosine and partial derivative (PDE) functions, the generic descriptors are PDE-textons.

After finding the texton library from a set of training images, images may be mapped with respect to the determined textons. Image models may be generated from database images. In one embodiment, each image in the database is filtered using the same set of linear and/or non-linear filters used to determine the textons. The image models may then be used for identification of a submitted image. A model of the submitted image is generated and compared to the database image models for identification.

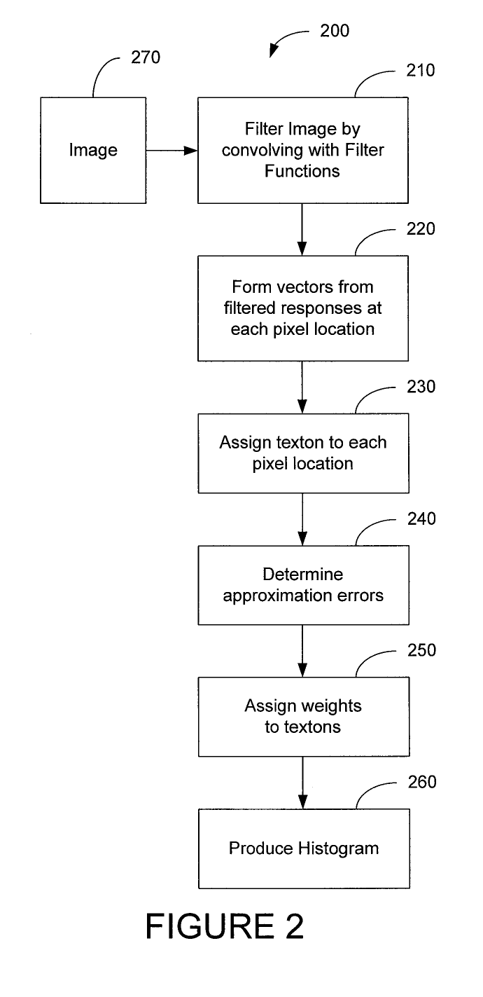

FIG. 2 is a flow diagram 200 illustrating a method for mapping an image using textons determined in FIG. 1 in accordance with an embodiment of the present disclosure. The functions {F₁, F₂, . . . , Fₘ} of filter bank 150 are convolved with a given input training image 270 in block 210 and the resultant filter responses, Fᵣ, are stacked to form an m-dimensional vector at each pixel location in the image in block 220. In some embodiments, the filter responses at each pixel position may be normalized.

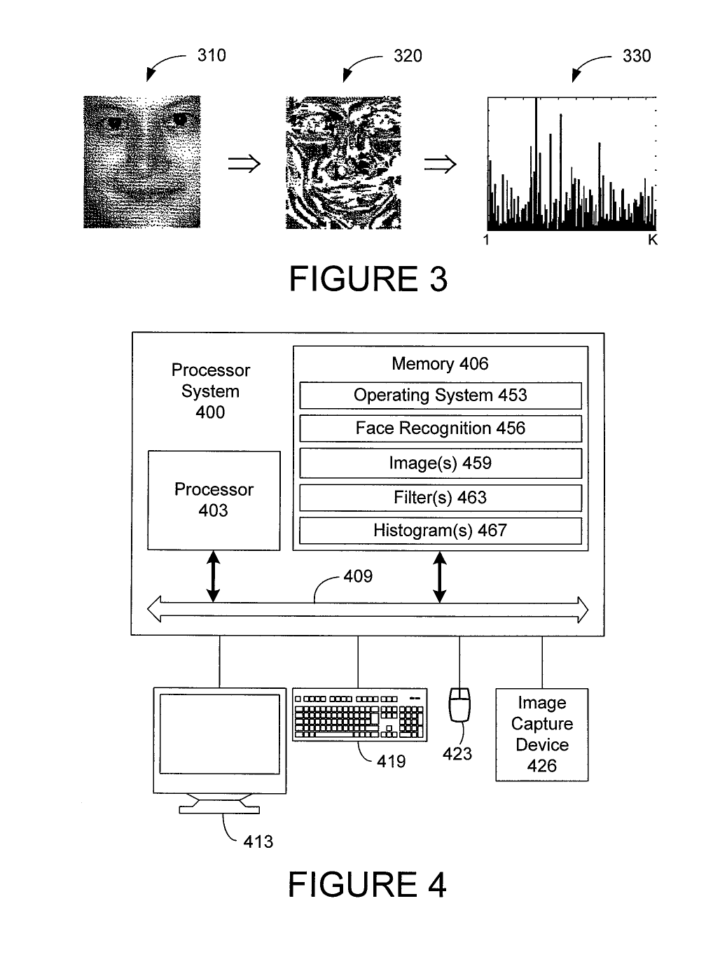

In block 230, the filter responses at each pixel are then compared with elements (i.e., textons) in the texton library, and assigned a texton-ID using a least squares fit. More precisely, if R_{c}={R_{c1},R_{c2}, . . . , R_{cK}} are the computed cluster centers or textons, then a pixel position (x, y) may be assigned a texton-ID, ω_{c}, by least square fit as follows:

$${ω}_{C} = {argmin}_{j} {\sum }_{n = 1}^{m} {( {F}_{n} * I - {R}_{cj} )}^{2} , \qquad j = 1 , 2 , … , K ,$$

where * is the convolution operator. A new image may be formed based upon the assigned texton-IDs associated with the texton library. This new image, constructed using the nearest texton for each pixel position, is referred to as the texton map. FIG. 3 is an illustration of mapping an image 310 to a texton map 320. In the embodiment of FIG. 3, the texton map 320 was generated using the 38 filters, and associated MR8-textons, described in “A statistical approach to texture classification from single images” by M. Varma and A. Zisserman (International Journal of Computer Vision, vol. 62, no. 1-2, pp. 61-81, April 2005), the entirety of which is hereby incorporated by reference. In an embodiment where the texton library includes PDE-textons, the new image is a PDE-texton map.

In block 240 of FIG. 2, an approximation error, E, is determined and recorded for each pixel and its assigned texton. In one embodiment, the approximation error is the difference between the original response and the response of the texton assigned to the pixel. The approximation error may be determined from:

$$E ( x , y ) = {\sum }_{n = 1}^{m} {( {R}_{nc} - {P}_{n} ( x , y ) )}^{2} ,$$

where R_{nc} is the m-length response vector of the assigned texton with texton-ID ω_{c} and Pₙ(x, y) is the m-length response vector of the pixel value at position (x, y) in the facial image.

Weights are assigned to the image pixels and their assigned textons in block 250. The weights may be based upon the approximation errors determined in block 240. In one embodiment, a linear weight is assigned to a pixel and its assigned texton based upon the corresponding approximation error at that pixel. In other embodiments, a spatially enhanced distribution of the texton map may be computed by dividing the image into blocks or regions for evaluation. In some embodiments the blocks may be of a fixed size, while in other embodiments the blocks or regions may vary is size based upon, but not limited to, image features or texton-ID assignments.

As described in “Face recognition based on appearance of local regions” by T. Ahonen, M. Pietikäinen, A. Hadid, and T. Mäenpää (Proceedings of 17th international Conference of Pattern Recognition, pp. 153-156, August 2004), the entirety of which is hereby incorporated by reference, for a given image, its texton map may be divided into different blocks or regions. The blocks or regions may be of a fixed size or may vary in size. For example, block sizes may vary based upon features of the original or filtered images. In one embodiment, block sizes may be based on the appearance of local regions in a facial image. For each block or region, energy of the corresponding regions in the residual image may be recorded. In one embodiment of the present disclosure, an average approximation error for a block may be determined based upon the approximation error for each pixel of the block. Linear weights are then assigned to the pixels and assigned textons on the average approximation error of the corresponding block. For example, the pixels and assigned textons corresponding to the largest error block are given the least weight, while those from regions (or blocks) with low average errors are given relatively large weights.

The assignment of weights to the assigned textons produces error encoded textons, which may be used to generate an error encoded texton map. In the embodiment using PDE-textons, the error encoded PDE-textons generate an error encoded PDE-texton map. To use texton maps for face recognition, a distribution (e.g., the histogram 310 of FIG. 3) of the textons-ids computed for the set of training images.

The error encoded textons (i.e., texton and assigned weight) are used to produce an error encoded histogram of the error encoded texton map in block 260. In one embodiment, the weights range from 0 to 1 and are used to scale the texton count for the histogram. The database of models (or histograms) produced from the set of training images may be used as the feature vectors for comparison purposes. For example, a histogram is produced for a new image using the method of FIG. 2 and compared to the database models to determine a possible match. In one embodiment, a nearest neighbor classifier such as, but not limited to, a χ² distance measure is used for comparing the distribution of textons from different image samples. Other distance measurements may also be utilized. In one embodiment, an identification may be indicated when the distance measure is less than a predefined threshold. In other embodiments, identification may be indicated when the distance measure is greater than a multiple of all other distance measurements. Other identification criteria may also be applied.

Referring next to FIG. 4, shown is one example of a system that performs various functions using face recognition according to the various embodiments as set forth above. As shown, a processor system 400 is provided that includes a processor 403 and a memory 406, both of which are coupled to a local interface 409. The local interface 409 may be, for example, a data bus with an accompanying control/address bus as can be appreciated by those with ordinary skill in the art. The processor system 400 may comprise, for example, a computer system such as a server, desktop computer, laptop, personal digital assistant, or other system with like capability.

Coupled to the processor system 400 are various peripheral devices such as, for example, a display device 413, a keyboard 419, and a mouse 423. In addition, other peripheral devices that allow for the capture of various patterns may be coupled to the processor system 400 such as, for example, an image capture device 426. The image capture device 426 may comprise, for example, a digital camera or other such device that generates images that comprise patterns to be analyzed as described above.

Stored in the memory 406 and executed by the processor 403 are various components that provide various functionality according to the various embodiments of the present disclosure. In the example embodiment shown, stored in the memory 406 is an operating system 453 and a face recognition system 456. In addition, stored in the memory 406 are various images 459, filters (or functions) 463, and histograms 467. The images 459 may be associated with a corresponding image capture device 426. Other information that may be stored in memory 406 includes, but is not limited to, filtered images, texton assignments, and weight assignments. The images 459, filters 463, and histograms 467 may be stored in a database to be accessed by the other systems as needed. The images 459 may comprise facial images such as the image 310 in FIG. 3 or other images as can be appreciated. The images 459 comprise, for example, a digital representation of physical patterns or digital information such as data, etc.

The face recognition system 456 is executed by the processor 403 in order to classify and recognize face images as described above. A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, or source code that may be expressed in proper format such as object code that is capable of being loaded into a of random access portion of the memory 406 and executed by the processor 403, etc. An executable program may be stored in any portion or component of the memory 406 including, for example, random access memory, read-only memory, a hard drive, compact disk (CD), floppy disk, or other memory components.

The memory 406 is defined herein as both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

The processor 403 may represent multiple processors and the memory 406 may represent multiple memories that operate in parallel. In such a case, the local interface 409 may be an appropriate network that facilitates communication between any two of the multiple processors, between any processor and any one of the memories, or between any two of the memories etc. The processor 403 may be of electrical, optical, or molecular construction, or of some other construction as can be appreciated by those with ordinary skill in the art.

The operating system 453 is executed to control the allocation and usage of hardware resources such as the memory, processing time and peripheral devices in the processor system 400. In this manner, the operating system 453 serves as the foundation on which applications depend as is generally known by those with ordinary skill in the art.

The flow charts of FIGS. 2 and 3 show the architecture, functionality, and operation of an implementation of the face recognition system 456. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although flow charts of FIGS. 2 and 3 show a specific order of execution, it is understood that the order of execution may differ from that which is depicted. For example, the order of execution of two or more blocks may be scrambled relative to the order shown. Also, two or more blocks shown in succession in FIGS. 2 and 3 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where the face recognition system 456 may comprise software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the face recognition system 456 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Experimental Validation

The methods were tested using a dataset of 120 classes, 65 men and 55 women, from “The AR face database,” by A. M. Martinez and R. Banavente (CVC Tech. Rep. No. 24, June 1998), the entirety of which is hereby incorporated by reference. All images in the dataset were cropped to 120×90 and no alignment or warping was performed on the images. In order to measure the performance of each algorithm, the actual image values for texture feature extraction was employed, i.e., no pre-processing was performed for any algorithm. Each class consisted of 13 frontal images (one neutral image and 12 different images with varying expressions, illumination, and occlusion). For appearance based algorithms (PCA & LDA), the first two images (frontal images; neutral and smiling) are used for training and the remaining eleven images for testing. For texture-based algorithms (LBP_{16,2}^{u2}, LM-textons, MR8-textons and PDE-textons), one training image with no expression was used as the model (120 images) and all the other images in the dataset for testing (a total of 1440 images for testing). At the texton learning stage, 10 images are randomly selected from the 120 training images. A total of 200 textons, cluster centers for all texton-based techniques, were determined. At the feature extraction stage, a region size of 15×18 is selected for all texton-based techniques (including the proposed error encoded PDE-textons). A region size of 15×18 is used for LBP_{16,2}^{u2}, since it was shown be the optimal window size for this algorithm.

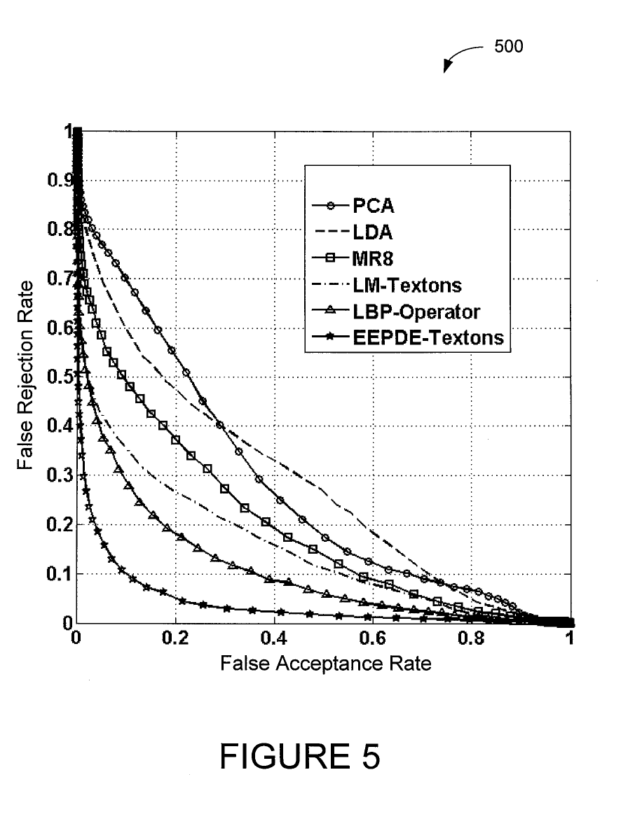

A Euclidean distance was computed for PCA and LDA, a χ² distance measure for LBP, LM-textons, and MR8-textons, and a weighted-χ² for the PDE-texton scheme, where the weights for bins are inversely proportional to the average approximation error in the residual image. FIG. 5 is a plot 500 of experimental results comparing face recognition schemes including error encoded PDE-textons (EEPDE-textons) in accordance with an embodiment of the present disclosure. As illustrated in FIG. 5, EEPDE textons exhibit superior performance when compared to other approaches.

It should be emphasized that the above-described embodiments of the present disclosure are merely possible examples of implementations, merely set forth for a clear understanding of the principles of the disclosure. Many variations and modifications may be made to the above-described embodiment(s) of the present disclosure without departing substantially from the spirit and principles of the disclosure. All such modifications and variations are intended to be included herein within the scope of this disclosure and the present disclosure and protected by the following claims.

Therefore, at least the following is claimed:

1. A method, comprising:
assigning a texton to each pixel of a filtered image to produce a texton map;
determining an approximation error for each pixel of the texton map;
segmenting the texton map into a plurality of sub-blocks, each sub-block associated with a plurality of pixels of the texton map;
determining an average error for at least one sub-block based upon the approximation errors of the pixels associated with the at least one sub-block;
determining a weight for the at least one sub-block based upon the average error;
assigning the weight to the textons assigned to the pixels associated with the at least one sub-block; and
producing an error encoded histogram based upon the textons and the assigned weights.

2. The method of claim 1, wherein the texton is a PDE-texton.

3. The method of claim 1, wherein assigning a texton to each pixel comprises:
determining a least square fit between a filter response vector associated with the pixel and a plurality of textons of a texton library; and
assigning the texton with the minimum argument to the pixel.

4. The method of claim 1, wherein assigning a texton comprises assigning a texton-ID corresponding to the assigned texton.

5. The method of claim 1, further comprising:
receiving an original image; and
filtering the original image to produce the filtered image, the filtered image including a filter response vector associated with each pixel of the filtered image.

6. The method of claim 5, wherein the original image is filtered using non-linear functions.

7. The method of claim 5, wherein the sub-blocks vary in size based upon regions of the original image.

8. The method of claim 1, wherein the sub-blocks are all the same size.

9. The method of claim 1, wherein the sub-blocks vary in size based upon features of the filtered image.

10. The method of claim 1, further comprising comparing the error encoded histogram to a database of histograms.

11. The method of claim 10, wherein comparing the error encoded histogram comprises determining a chi-square distance measure between the error encoded histogram and at least one histogram of the database.

12. A method, comprising:
assigning a texton to a pixel of a filtered image;
determining an approximation error associated with the pixel;
determining a weight associated with the texton assigned to the pixel, the weight based upon the approximation error associated with the pixel; and
producing an error encoded histogram based upon the texton and the associated weight.

13. The method of claim 12, wherein the texton is a PDE-texton.

14. The method of claim 12, wherein assigning a texton to a pixel comprises:
determining a least square fit between a filter response vector associated with the pixel and a plurality of textons of a texton library; and
assigning the texton with the minimum argument to the pixel.

15. The method of claim 12, wherein assigning a texton comprises assigning a texton-ID corresponding to the assigned texton.

16. The method of claim 12, further comprising:
receiving an original image; and
filtering the original image to produce the filtered image, the filtered image including a filter response vector associated with the pixel of the filtered image.

17. The method of claim 16, wherein the original image is filtered using non-linear functions.

18. The method of claim 12, wherein determining a weight comprises:
determining an average error associated with a region of the filtered image including the pixel, the average error based in part upon the approximation error associated with the pixel; and
determining the weight based upon the average error.

19. A system, comprising:
means for assigning a texton to a pixel of a filtered image;
means for determining an approximation error associated with the pixel;
means for determining a weight associated with the texton assigned to the pixel, the weight based upon the approximation error associated with the pixel; and
means for producing an error encoded histogram based upon the texton and the associated weight.

20. The system of claim 19, wherein the texton is a PDE-texton.

21. The system of claim 19, wherein the means for assigning a texton to a pixel comprises:
means for determining a least square fit between a filter response vector associated with the pixel and a plurality of textons of a texton library; and
means for assigning the texton with the minimum argument to the pixel.

22. The system of claim 19, further comprising:
means for receiving an original image; and
means for filtering the original image to produce the filtered image, the filtered image including a filter response vector associated with the pixel of the filtered image.

23. The system of claim 19, wherein the means for determining a weight comprises:
means for determining an average error associated a region of the filtered image including the pixel, the average error based in part upon the approximation error associated with the pixel; and
means for determining the weight based upon the average error.

24. The method of claim 19, wherein the means for assigning a texton comprises means for assigning a texton-ID corresponding to the assigned texton.
